(19) United States
(12) Patent Application Publication
(10) Pub. No.: US 2006/0263594 A1
(43) Pub. Date: Nov. 23, 2006

(54) Optional liner based pressure sensitive intermediate assembly

(75) Inventors: Roger E. Kraft, Fort Scott, KS (US); Jesse D. Crum, Fort Scott, KS (US); William R. Russell, Pittsburg, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/190,381

(22) Filed: Jul. 26, 2005

Related U.S. Application Data
(63) Continuation-in-part of application No. 11/135,481, filed on May 23, 2005.
(63) Continuation-in-part of application No. 11/135,179, filed on May 23, 2005.
(63) Continuation-in-part of application No. 11/135,131, filed on May 23, 2005.

(51) Int. Cl. B32B 7/12; B32B 37/00; B32B 38/04; B32B 38/14

(52) U.S. Cl. 428/343; 156/277; 156/289; 156/265; 156/272.2; 156/266; 428/345; 156/247

(57) ABSTRACT

The present invention is directed to a continuous system for creating high quality pressure sensitive products that can be provided in both a linered and liner free arrangement. The process provides the ability to variably image individual portions of a sheet that is then cut into separate segments which form the intermediate label portions. A release material is applied over one surface of the segment and directly over the printed areas and a pattern of pressure sensitive adhesive is applied to a second surface opposite that of the first surface. The label segments may be die cut and are then may be placed on a temporary carrier web or alternatively can be positioned in a slightly overlapping arrangement to create a temporary web to transport the label segments to a collection or use location.

### CROSS-REFERENCES TO RELATED APPLICATIONS

This application is a continuation-in-part of application Ser. No. 11/135,481 filed May 23, 2005, Ser. No. 11/135,179 filed May 23, 2005 and Ser. No. 11/135,131 filed May 23, 2005 the disclosures of each of which including that found in the claims is incorporated herein by reference.

### FIELD OF THE INVENTION

The present invention is in the field of composite, intermediate manufacturing methods that are used in the preparation of articles, such as pressure sensitive laminates intended for use as a prime label. More particularly, such laminated assemblies may be used in the production of prime label products which may be provided to an end user with or without a liner or carrier web assembly.

The present invention is used to produce business and marketing communications that are manufactured in a unique and continuous process. The instant specification may include providing a temporary, continuous carrier web of a material, then applying a number of discrete, previously prepared and high quality, pre-printed segments over the top of the carrier web to create an intermediate assembly that may be further processed, such as by die cutting, to produce communications that can be used to convey information or aid in developing or advancing a promotion. Alternatively, the pressure sensitive intermediates may be linked to one another in a slightly overlapping or shingled configuration to a stacked configuration.

The segments, which represent an area of printable stock material, are produced in part, initially from a pre-imaged or pre-printed sheet that is then cut, converted or merged to a continuous type of format through use of a placer mechanism that sequentially places the cut pieces in an overlapping arrangement or alternatively on a temporary web to create a partially laminated assembly.

The sheets are preferably printed with high quality graphics or images which are then slit or cut to size (regular and irregular shapes) to form templates, ribbons, surface elements or segments for the particular application. The segments are coated with silicone or other high release material then converted to or merged to create a continuously advancing web of material which may include a carrier web in order to create a continuous, intermediate, at least partially laminated roll format. The segments that have been affixed to the web are provided in one or more intermediate laminated configurations to an end user. By using the process of the present invention high quality graphics can be prepared to further enhance the particular offering that is being created. More particularly, the pressure sensitive intermediate of the instant application can be used to create individual, prime label products having a high or photo quality resolution level such as those about 300 lines per inch or approximately 2500 to 3500 dots per inch.

### BACKGROUND OF THE INVENTION

Today, there are wide varieties of product offerings available that serve multiple purposes and functions, including product offerings that are used in fulfilling the needs in the prime label market. Conventional processes that are used today in creating prime labels are typically based on a continuous web technology using flexographic presses. The traditional process of manufacturing such label products, includes the feeding of a continuous web of material, such as a preformed web of pressure sensitive laminate, which normally consists of a top ply having a layer of adhesive on its underside that is covered by a release liner to form the laminate assembly through the press. The web is then processed through a press, typically a flexographic press, and an image is applied to the web by various stations. The web may then be collected, die-cut and the individual labels removed and applied.

Flexography is commonly used today for the production of prime label substrates as well as for the printing of decorative items, including the rendering of packaging. The technology employs a series of plates and one or more stations, containing inks (usually a different colored ink at each station), to apply colored images to the web as the web traverses the press. Through improvements in ink qualities and other modifications and enhancements in the technology, the image quality in flexographic presses and resulting products has improved to about 150 lines per inch.

For a point of reference, typically, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms, in cooperation with electronic scanners and image setters, to produce halftone images that are to be subsequently used to render an image. The pixels of digitized images are first assembled into dots that are then used to form shapes, sizes, rulings, etc. which create the ultimate image produced on the substrate.

While flexographic technology or flexography is desirable for use in such printing, due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy” or other images, such as those that use flesh tones or deep or rich colors, look faded or “washed out”. The effects of this level of image resolution can detract from the product appearance which may diminish the value of the technology and the products produced particularly for the prime label market. With increasing sophistication of consumers, as well as technology and expectations from each, such effects may be undesirable to potential end users.

Flexography also suffers from other drawbacks, such as the time involved in preparing a job to run or “make ready” as it may otherwise be known. That is, the steps that are used to prepare the flexography equipment for running a particular job or order. This make ready includes such activity as the preparation of multiple plates to produce the image at each station, mixing inks, calibration and alignment of the images between stations and the like. Operation of the flexography presses may also include multiple operators, which can add to manufacturing costs.

Waste can also be a problem with such conventional printing technologies in that a number of feet, yards or meters of web material must be processed through the press in order to have the colors reach a predetermined threshold and to ensure appropriate registry of the stations as they are printing the images on the web. The amount of material wasted can be several times the length of the press or up to several hundred feet of material. The use of such volumes of materials obviously increases the cost of the operation. Thus, due to the make ready and waste factors, the production of products, such as prime labels, using flexography may then be limited to serving only certain market segments, namely large market segments.

Another drawback believed to be associated with flexographic technologies is that the technology may not be able to provide any variability in the product, including such basic functionality as sequential numbering, addressing or adding promotional text in connection with a seasonal advertisement or other offering without the addition of further processing stations and investment in equipment. If such features are required by an end user or customer, such as with product date or coding, this function generally cannot be performed by flexographic presses without the inclusion of additional stations and instead typically must occur through an off line operation, such as in an ink jetting operation, often after the label web has been removed from the press and the individual labels have been applied to the container or carton. Alternatively, the ink jetting may be performed directly on the container as part of a separate operation.

Flexographic presses normally have a number of pre-determined stations, for example a four color press may have only four stations that can be used to treat or process the web. Thus, if other stations are to be added, such as a numbering head, the manufacturer likely then has to reduce the number of colors that can be added to the web as one station has been surrendered for the numbering head.

Flexographic technology also limits the ability to add personalization to products produced on such presses. This may be particularly desirable in certain market segments such prime label products on consumer package goods (“CPG”), which may further enhance the product or service offering by making the product more attractive to prospective purchasers, thereby increasing the appeal to the consumer of the product or service.

Conventional pressure sensitive assemblies normally include a substrate having on one side a coating of adhesive, that is normally tacky to the touch, and a release liner disposed in a facial relationship with the adhesive to prevent the adhesive from coming into contact with the various processing surfaces of the apparatus that is handling the web of pressure sensitive material. The liner material will typically consist of a highly calendared stock to which a layer of silicone has been applied to one side of the stock. In use, the liner material is stripped away from the pressure sensitive adhesive assembly and is normally discarded. The adhesive will remain with the substrate to which it was originally applied as the adhesive has a greater affinity for the label substrate or sheets than for the carrier web or liner material as the label segments do not have a release coating applied to the surface in contact with the adhesive.

Discarding of the carrier web or liner material has always been looked on as being wasteful as normally the liner material simply finds its way to the local landfill. In addition, in certain jurisdictions, additional fees may accompany the disposal of such materials as the materials cannot generally be recycled due to the silicone coating resident on the liner or carrier web of material.

Such environmental concerns lead to the development of “linerless” pressure sensitive products in which a continuous substrate was coated on one side with a silicone or other release material and on the other or opposite side with a pressure sensitive adhesive. This “all in one” type arrangement then permitted the web of labels to be wound onto itself and then unwound for application. The silicone coating on the one surface thereby allowing the adhesive to be unwound from the roll of material.

There are however certain problems associated with such linerless constructions. Initially, if the silicone layer is not adequately secured to the substrate, the silicone will peel off when the web is unwound as the adhesive pulls the release material off the substrate. This can have the effect of blocking the adhesive and preventing the label from sticking to the intended surface.

The silicone covering can also make printing or imaging over the silicone difficult as the ink or toner may be prevented from being fully adhered to the surface thus permitting the imaging or printing to become smudged or smeared on contact. Alternatively, if the toner or ink does not bond at all with the surface the entire image or print may be wiped completely away from the surface on which it had been printed.

Linerless solutions, while seeming to solve the environmental concerns addressed above were also more expensive to manufacture than conventional linered products. Thus, while potential users realized the possible environmental friendliness of the construction, the additional cost associated with the linerless product was simply too much for most users of traditional linered pressure sensitive products to switch to the linerless solutions.

What is needed therefore is a process by which a label substrate having high release properties can be produced with high quality, variable graphics on demand for prime label applications. Such a label would ideally have a resolution that is in excess of at least about 150 lines per inch and which can be manufactured in an efficient and cost effective manner, such as in a continuous system operating at greater than fifty feet per minute. Moreover, a method which can add substantial variability to the product as well as other features, such as embossments, over laminates, variable printing, additional elements or imaging and the like, would greatly expand the penetration of this form of business communication in the marketplace.

The present invention seeks to provide a method for producing an innovative prime label intermediate, that may be offered in a linerless or liner free type of format and which has a quality of about 150 or more lines per inch and preferably more than 300 lines per inch, which is approximately equal to about 2500 to 3500 dots per inch (“DPI”), in order to create a high quality image that is intended to be aesthetically appealing to the consumer. The prime label intermediate may be cut into individual sheets, provided in stacks or shaped sheets to further add to this unique offering.

Through the development of the present system and the creation of the unique intermediate web assembly described in this invention, the manufacturer can now service a particular niche market segment for creating high quality templates in a continuous fashion, such as those ranging from approximately 100 to 1,000,000. While the foregoing market size or segment is a target area of the present invention, it should be appreciated that the invention may be practiced and used to fulfill larger order quantities, such as those of a million or more.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Unexpectedly, it has been discovered that there is no readily available process or system by which a manufacturer can create high quality, prime labels having a high release coating and significantly improved graphic resolution that is greater than at least about 150 lines per inch, preferably greater than about 200 lines per inch and still more preferably about 300 lines per inch, in an efficient and cost effective manner. The development of the present system, process and the creation of the unique intermediate continuous assembly described in this invention permit the servicing of a particular niche market segment for glossy prime labels, that of approximately 100 to 1,000,000 prime labels. While the foregoing market size or segment is a target area of the present invention, it should be appreciated that the invention may be practiced and used to fulfill larger order quantities, such as those of a million labels or more.

The pressure sensitive intermediate of the present invention is created through a unique process, which provides savings when compared with conventional flexography process and other manufacturing processes related to pressure sensitive products, specifically through reduced make ready time and generation of waste material. In addition, through practice of the present invention the resulting process yields an intermediate product having a higher image resolution product when compared with conventionally produced prime label constructions.

The present invention uses previously prepared individually created sheets, or segments, that have high resolution imaging or printing already applied to the sheets, e.g. graphical depictions, before the sheets are provided to the manufacturing press. The sheets, ribbons or segments may be applied to an intermediate web or prepared in a continuous format in a number of patterns, including substantially edge-to-edge configuration, with a slight overlap, offset stacks, vertically aligned stacks or alternatively, provided in regularly occurring increments depending on the needs of the particular application to be serviced. In addition, the product produced in connection with the present process described in the instant application is not limited in functionality as a number of materials, operations and options may be used in creating a relatively dynamic product. Such additional processes may include variable printing, embossments, coatings, over laminates and the like.

By preparing the intermediate prime label assembly in the manner described herein, the intermediate web can be processed continuously at speeds of greater than 50 feet per minute, preferably between 75-150 feet per minute and still more preferably at speeds of about 200 feet per minute or greater.

In one exemplary embodiment, a pressure sensitive assembly produced in accordance with the following process is described through reference to the following steps. Initially, high quality resolution indicia is imaged on at least one sheet in a number of predefined areas. Then, the sheet is cut in to a number of individual segments with each segment representing at least one of the predefined areas. Each segment contains indicia and each segment has first and second faces, first and second transversely extending edges and first and second longitudinally extending sides.

Each of the segments are then fed individually to a first coating station where a release layer is applied to the first face over the indicia and between the first and second longitudinally extending sides and first and second transversely extending edges. A pattern of pressure sensitive adhesive may be applied to the second face of each of the segments which is opposite the first face.

Each of the segments is then sequentially applied to a temporary carrier web and after traversing the manufacturing apparatus; each of the segments is removed from the temporary carrier web and are positioned in at least a partially overlapping configuration with one another to create a pressure sensitive assembly having at least two release coated prime labels.

In a still further exemplary embodiment of the present invention, a liner free stackable pressure sensitive assembly is described and produced in accordance with the following process that utilizes the steps of initially printing high resolution quality variable and fixed indicia on a surface of at least one sheet with the printing appearing in a number of pre-determined areas. Then, the sheet is separated into a number of distinct individual ribbons with each of the ribbons including one pre-determined area with the printing.

Each of the ribbons is supplied to a placer mechanism that sequentially and continuously feeds each of the ribbons to a coating station where a first surface of each of the ribbons is coated with a silicone release material over the printing and a pressure sensitive adhesive applied to a second surface of each of the ribbons, the second surface is opposite that of the first surface.

Each of the ribbons are arranged sequentially to form a temporary web assembly such that a portion of the first release coated surface of a first ribbon is disposed at least partially beneath the second adhesive coated surface of a second ribbon.

In yet a still further embodiment of the present invention, a process of producing a liner free pressure sensitive assembly is described and includes the steps of initially providing a series of sheets of printable stock material, with each of the sheets having first and second surfaces, first and second longitudinally extending sides and first and second transversely extending edges. In addition, each of the sheets has a number of predefined areas for receiving indicia. High resolution quality printing is then produced, such as by imaging, rendering or printing in each of the predefined areas on the sheets. The sheets are the cut into individual segments, with each segment having first and second faces with and containing at least one predefined area on at least the first face. A coating of release material is applied over the first face and over the predefined areas and a pressure sensitive adhesive is patterned on the second face of each of the segments.

Each of the segments are then placed continuously, sequentially on a temporary carrier web and then the temporary carrier web is removed from each of the segments allowing the segments to be stacked one upon the other or alternatively, placed in a shingled or overlapping configuration, with the overlap extending generally greater than about 1/64 of an inch.

The individual segments or ribbons that are used in connection with the practice of the present invention may be die cut by using electromagnetic radiation in one of the ultraviolet, visible or infrared regions of the light spectrum, or laser die cutting as it is more commonly known.

The above referenced embodiments may also include subjecting the segments after coating, either with silicone, adhesive or both to a step of curing in which preferably, ultraviolet energy is used to cure the coatings. Such a curing may be accomplished prior to the step of placing the segments on a carrier web.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a cross sectional view of a pressure sensitive label prepared in accordance with the present invention;

FIG. 1A shows a printable sheet which as been imaged in a number of pre-determined areas with indicia;

FIG. 2 presents a view of the underside or second surface of the label web showing the carrier strips and overlapping arrangement of the pressure sensitive label segments;

FIG. 3 illustrates a schematic of the apparatus used in preparing the pressure sensitive intermediate assembly of the present invention;

FIG. 4 provides a side view of a stack of pressure sensitive products prepared in accordance with the present invention;

FIG. 4A shows an overlapping configuration of a number of pressure sensitive labels prepared in accordance with the present invention; and

FIG. 5 provides a block diagram of an exemplary process used in carrying out the manufacture of the pressure sensitive products of the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The term “prime label” as used herein refers to a label or other identification piece that may be used interchangeably with labels, such as tags, typically having a pattern of adhesive disposed on one side of a substrate and one or more graphical illustrations or depictions on the opposite side. Some level of textual messaging may also be provided on the face of the label. The adhesive is typically a pressure sensitive adhesive but may also include activatable adhesives such as thermally or moisture sensitive materials. However, it should be understood that all prime labels need not be provided with an adhesive.

Prime labels are further distinguished from other labels in the art in that such labels are known as having a high level of quality or value. The term prime label is often used to describe a type of label that is the highest grade marketed in a particular industry. Prime labels find application in a number of exemplary areas but have found wide range acceptance particularly in the area of consumer packaged goods (“CPG”) and other products for which the prime label is an effective means for communicating a specific message or for enhancing the image of the manufacturer or distributor or presenting the product as a high quality item. Prime labels are also used for business communications in that they can convey certain desirable criteria, image, brand recognition or information and can be used independently of a product, such as in connection with advertising a service opportunity or offering, or with other activities or undertakings, such as for example non-profit organizations.

Prime labels, particularly prime labels prepared in accordance with the present invention, may also contain printed messages, including personalized and/or variable information in addition to the graphical displays. The printed messages can be fixed or static, as will be explained herein, may be personalized or sequentially numbered or provided with other unique or special identifiers.

The term “patterns” as used herein refers to strips, lines, shapes, spots, dots, elements and discontinuous segments, as well as regular and irregular placement of such items. Patterns may also refer to combinations of the above-mentioned items such that one pattern may be a continuous strip; another, segmented elements; and a still further irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters, and the like. Patterns are used in connection with the present invention to describe the placement of the label segments or ribbons applied to the web or individual prime labels positioned on the web in a particular pattern or arrangement. Pattern as defined herein also is used in connection with the adhesive that is applied to the continuous web.

As used herein, the term “business communication piece or document” refers to a substrate that, either alone or in combination with other documents, can convey a particular message or image or provide information about a particular product or service that is available from the provider of such pieces or documents. Business communication documents or pieces can include advertising, sales and marketing collateral and such other items used to convey information on written or imaged form sheets, brochures, presentation folders, informational sheets and combinations thereof.

The term “personalized information” refers to information that is printed or imaged onto a substrate, which is generally variable or unique and which may change from document to document or segment to segment so as to create a customized message or communication for each recipient. Examples of personalized information may include names, addresses, descriptions, plans, coding, numbering, promotional text, etc. that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc. that may be of interest to the intended recipient and represents a standard message that the manufacturing or supplier wishes to convey to an end user or customer of the offering.

The term “intermediate” as used herein refers to a product that undergoes one or more processing steps prior to the intermediate reaching a final condition, that of being ready for end use or application. The additional processing steps may include printing, imaging, folding, sealing, separating, cutting, perforating, scoring, adhering and the like. Typically, a product such as with the present invention is provided in an intermediate condition so that a user can add or manipulate the intermediate to create the final or desired end product, such as applying the prime label to a container, carton or the like. Thus, in accordance with the present invention, the intermediate segment, for example, could be subject to die cutting or additional printing, such as through ink jetting, over laminating, coating or embossment, and then applied to a container, carton, consumer package good or the like.

The term “sheets” or “segments” as used herein refers to sheets, segments, ribbons, strips, pieces, parts, sections, subdivisions and combinations thereof. The sheet or segment provided as an example for the purposes of this specification can be an entire sheet such as 8½″×11″, 11″×14″, 19″×25″ and other known sheet sizes or may be segments, divisions, strips, etc. of such sheets. For example, a 19″×25″ sheet may be produced with five rows of labels, with each row having six labels, with each label having dimensions of approximately 3″×4″. For instance, in this example, each row may comprise an individual segment or sheet that may be used in practicing the present invention. It should, however, be understood that the invention is not to be so limited to the foregoing configuration that individual pieces or elements, regardless whether the piece or elements have a regular or irregular shape, may be used in connection with this process to produce the intermediate assembly that is described in this application.

An exemplary high resolution imaging device that is used in preparing the areas of the sheets that will become the prime label segments as well as the film, if the film is preprinted, used to cover the segments in accordance with the present invention includes an Indigo®, available from Hewlett Packard of Palo Alto, Calif. or Karat available from KBA of Williston, Vt. The present invention seeks to provide a prime label segment or intermediate that has a quality of at least about 150 or more lines per inch and preferably more than 300 lines per inch, which is approximately equal to about 2500 to 3500 dots per inch (“DPI”) in order to create a high quality image that is intended to be aesthetically appealing to the consumer.

An exemplary placer, feeder or insertion device that is used in the practice of the present invention is a Maverick® unit that is available from In-Line Automation of Minneapolis, Minn. The unit may use vacuum cylinders, belts or other suitable transfer means to transfer the individual segments to the web of material.

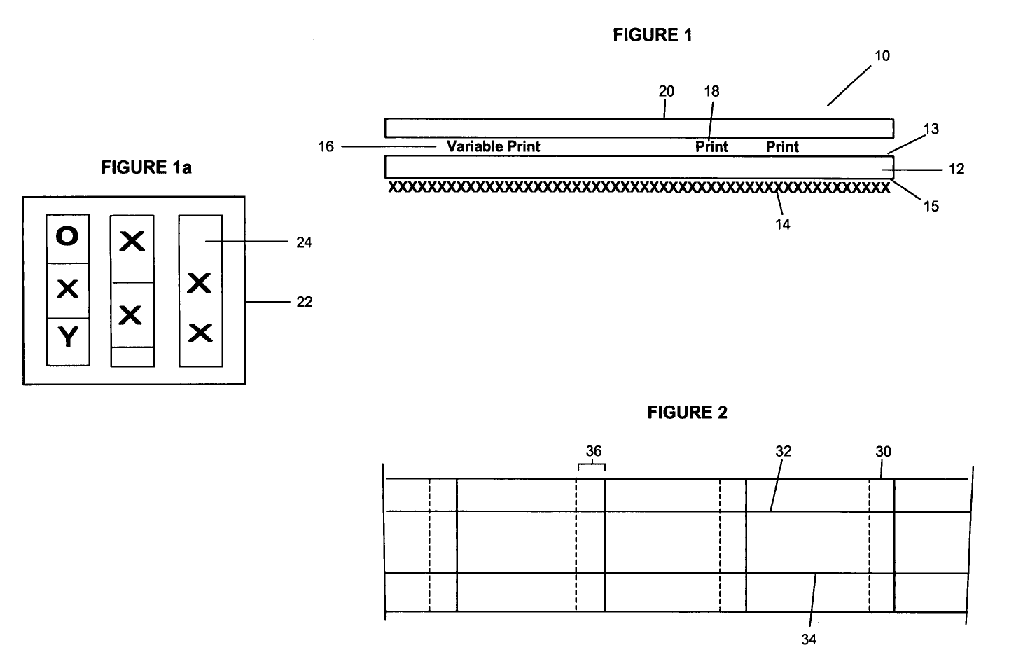

Reference is now directed to FIG. 1 in which a cross sectional view of an intermediate pressure sensitive product is depicted and designated generally by the numeral 10. The pressure sensitive intermediate 10 is prepared from a printable substrate that has been severed into individual segments 12. See FIG. 1A which shows the sheet 22 printed in a number of pre-determined areas 24. Each of the printed areas will become the label segments. It should be understood that while the printed areas are shown generally as rectangular block, any geometric, animate or inanimate pattern is of course possible. In addition, further shapes can be cut from the initial segments. For example, if the initial segment is rectangular a series of circles, stars or the like could then be die cut from the segment to produce shaped label portions.

The segment 12 has first and second surfaces 13 and 15. The second surface 15 is provided with a pattern of adhesive 14. The first surface 13 is printed with variable printing 16 and static or fixed printing 18. A layer of silicone or other high release material 20 is provided over the top of the printing to protect the imaging on the surface. It should be understood that by being able to render individually printed areas on the sheet shown in FIG. 1A, many of the disadvantages of conventional linerless products may be overcome in that the print does not need to be applied over the surface of the release material. That is, the sheet which includes a number of segments may be printed on demand and the individual segments inserted in the system without the need for further printing. This represents an improvement over previous linerless systems in that the prior systems were produced in a continuous web configuration and the printing applied to the web was substantially constant.

FIG. 2 provides a view of the underside or second face or surface of a label assembly 30 showing the temporary carrier web strings 32 and 34. The assembly 30 is shown in an overlapping configuration as represented by the area of the overlap shown by bracketed area 36. Preferably, the area of the overlap of successive label segments will be greater than about 1/64 of an inch and preferably less than an inch and more preferably less than a half of an inch. The underside or second surface of the label assembly may be provided with printing and in such instances, the adhesive may desirably be substantially translucent or transparent so that the imaging or printing will be visible through the adhesive.

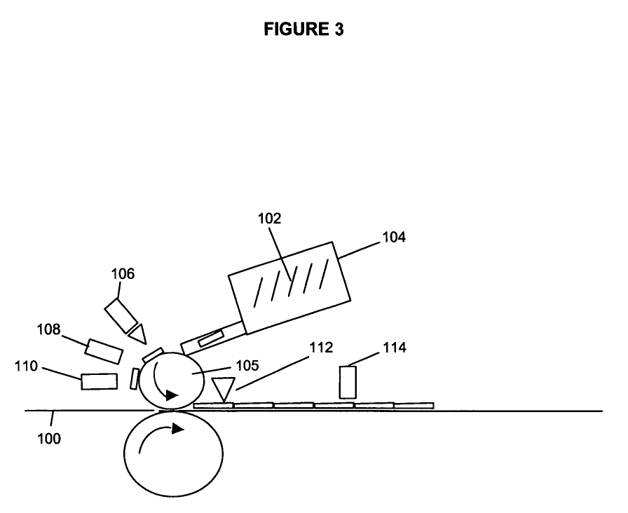

FIG. 3 provides a schematic of an exemplary apparatus used in manufacturing the pressure sensitive assembly of the present invention. A carrier web 100, which may be a pair of strings, mesh of material or conventional liner material is advanced in a machine direction.

A series of label segments 102 is supplied to a hopper of a feeder mechanism 104 and the individual segments are supplied to a rotary device, such as a vacuum cylinder 105 which will move the segments under each of the coating or treatment stations. The segment is passed to a first coating station 106 which may apply a pattern of adhesive to the segment. The segment is then rotated past a curing station 108 and then a die cutting station at 110 which cuts the segment into the particular shape or orientation. The matrix associated with the label segment may remain with the segment until a further processing station downstream when the matrix is removed.

The segments are then placed on the web 100 and a coating of silicone is applied over the first surface at station 112 and then cured at station 114. Alternatively, the silicone can be applied prior to the segments being placed in the hopper mechanism for the feeding device. In this arrangement, the silicone release coating can be applied over the sheet of material so that it is on the pre-determined areas when the label segments are cut or separated from the sheet. The pre-application of silicone or other release material may help in the feeding of the individual segments from the hopper due to reduced drag or friction between successive segments.

In either arrangement, the label segments on the web are moved to a collection point where the carrier web may be removed and the label segments collected. It should be understood that by creating a particular overlapping or shingling arrangement the adhesive of one label segment will temporarily secure one label to another as the adhesive is in contact with the release surface of the successive label segment.

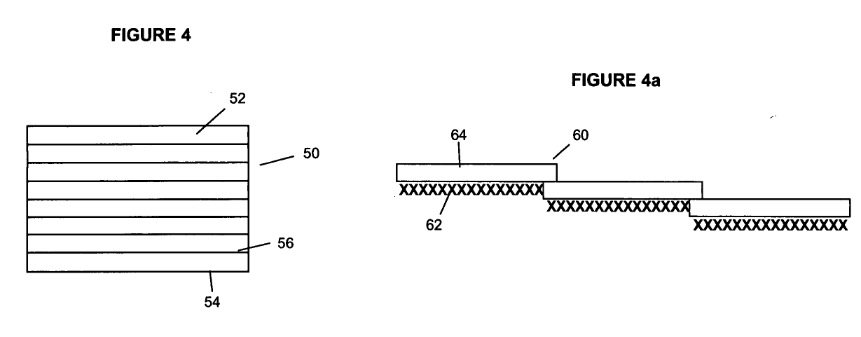

FIG. 4 of the present invention shows a stack of label segments 50 showing a series of individual labels 52. Each label will have a coating of adhesive applied to its underside 54 and a layer of silicone applied to the first face or upper side at 56. While the stack is shown in a substantially vertical arrangement, the stack can be provided in which the individual label sheets are slightly offset from one another.

FIG. 4A shows an overlapping arrangement of pressure sensitive segments 60 in which an adhesive is provided on the underside 62 and a release material 64 on the upper side. In such an arrangement, the slight overlap is used to hold the label segments in position as the adhesive provides a temporary hold onto the release surface. In addition, where the matrix remains with the label segment, the matrix may be contained in the area of the overlap such that when the matrix is removed the overlap no longer exists between the label segments. The overlap between successive label segments will preferably be about 1/64 of an inch or greater.

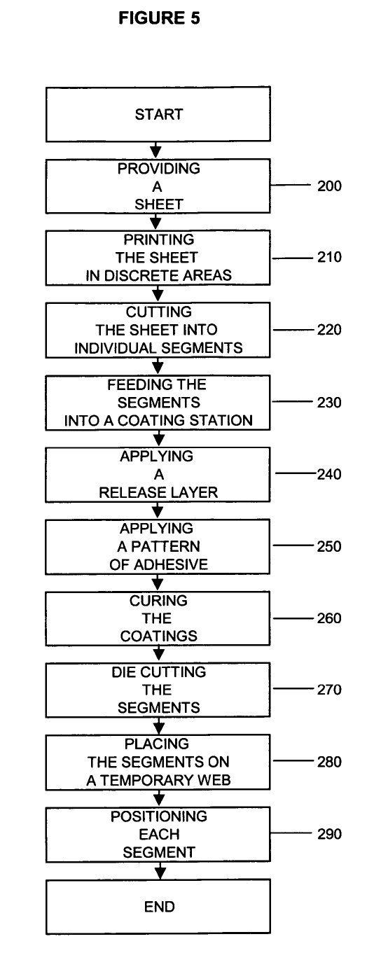

FIG. 5 presents a block diagram of an exemplary process used in practicing the present invention. A sheet of printable material is provided at step 200. The sheet is printed in a number of discrete areas at step 210 and is then cut into individual segments at step 220. Each of the segments is then fed to a coating station at step 230 by a placer mechanism as shown in FIG. 3. A release layer is applied at step 240 and a pattern of adhesive is applied at step 250. It should be understood that application of the adhesive and release may occur in this order or reverse order. In addition, the release material may be applied prior to the segments being supplied to the placer mechanism.

Next, one or more of the coatings is cured at step 260. Preferably, the coating will be cured by ultraviolet energy. The segments will then be die cut at step 270 to create the desired shape that the final pressure sensitive label will take. Then the segments are placed on a temporary carrier web at step 280, if one is used, where each segment is positioned in a pre-determined arrangement, step 290, ranging from spaced to slightly overlapping to substantially vertically juxtapositioned on one another. If no carrier web is provided, the label segments will be placed in either a slightly overlapping configuration, or alternatively, the label segments may be stacked one on top of the other or in any other sort of stacking pattern.

It will thus be seen according to the present invention a highly advantageous pressure sensitive intermediate has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A pressure sensitive assembly produced in accordance with the following process and comprising the following steps;
imaging high quality resolution indicia on at least one sheet in a number of predefined area;
cutting said sheet in to a number of individual segments with each segment representing at least one of said predefined areas and each segment containing indicia and each segment having first and second faces, first and second transversely extending edges and first and second longitudinally extending sides;
feeding each of said segments individually to a first coating station
applying a release layer to said first face over said indicia and between said first and second longitudinally extending sides and first and second transversely extending edges;
placing each of said segments sequentially on a temporary carrier web;
removing each of said segments from said temporary carrier web; and
positioning each of segments in at least a partially overlapping configuration with one another to create a pressure sensitive assembly having at least two release coated prime labels.

2. A pressure sensitive assembly as recited in claim 1, wherein the process includes a further step of die cutting each of said segments after the step of feeding each of said segments.

3. A pressure sensitive assembly as recited in claim 2, wherein said step of die cutting is performed by using electromagnetic radiation in one of the ultraviolet, visible or infrared regions of the light spectrum.

4. A pressure sensitive assembly as recited in claim 1, wherein the process includes a further step of curing said release layer prior to the step of removing each of said segments from said temporary carrier.

5. A pressure sensitive assembly as recited in claim 4, wherein said curing is accomplished through use of ultraviolet energy.

6. A pressure sensitive assembly as recited in claim 1, wherein the step of positioning is accomplished by substantially juxtapositioning each of said segments directly over another of said segments.

7. A pressure sensitive assembly as recited in claim 1, wherein the step of positioning is accomplished by providing an overlap of less than about one inch.

8. A pressure sensitive assembly as recited in claim 7, wherein the step of positioning is accomplished by providing an overlap of less than about one half of one inch.

9. A pressure sensitive assembly as recited in claim 7, wherein the step of positioning is accomplished by providing an overlap of less than about 1/32 of an inch.

10. A pressure sensitive assembly as recited in claim 1, wherein said temporary carrier web consists of a plurality of individual strings.

11. A pressure sensitive assembly as recited in claim 1, including a further step of coating said second face of each of said segments with a pattern of pressure sensitive adhesive prior to the step of placing each of said segments.

12. A liner free stackable pressure sensitive assembly produced in accordance with the following process and comprising the steps of;
printing high resolution quality variable and fixed indicia on a surface of at least one sheet, said printing appearing in a number of pre-determined areas;
separating said sheet into a number of distinct individual ribbons with each of said ribbons including one pre-determined area with said printing;
supplying each of said ribbons to a placer mechanism;
feeding each of said ribbons to a coating station;
coating a first surface of each of said ribbons with a silicone release material over said printing;
applying a pressure sensitive adhesive to a second surface of each of said ribbons, said second surface is opposite that of said first surface; and
arranging, sequentially each of said ribbons to form a temporary web assembly such that a portion of said first release coated surface of a first ribbon is disposed at least partially beneath said second adhesive coated surface of a second ribbon.

13. A liner free stackable pressure sensitive assembly as recited in claim 12, wherein said printing is provided at a resolution level of greater than about 150 lines per inch.

14. A liner free stackable pressure sensitive assembly as recited in claim 12, wherein the step of arranging is practiced by substantially juxtapositioning each of said ribbons directly over one another such that said ribbons are substantially vertically aligned with one another to create a stack.

15. A liner free stackable pressure sensitive assembly as recited in claim 12, including a further step of die cutting each of said ribbons prior to the step of arranging each of said ribbons to form a temporary web.

16. A liner free stackable pressure sensitive assembly as recited in claim 12, wherein the step of arranging is accomplished by providing an overlap between each of said ribbons an amount greater than about 1/64 of one inch.

17. A process of producing a liner free pressure sensitive assembly, comprising the steps of;
providing a series of sheets of printable stock material, each of said sheets having first and second surfaces, first and second longitudinally extending sides and first and second transversely extending edges, each of said sheets having a number of predefined areas for receiving indicia;
producing high resolution quality printing in each of said predefined areas on said sheets;
cutting said sheets into individual segments, with each segment having first and second faces with each segment containing at least one predefined area on at least said first face;
applying a coating of release material over said first face and over said predefined areas;
patterning a pressure sensitive adhesive on said second face of each of said segments;
placing each of said segments continuously, sequentially on a temporary carrier web; and
removing said temporary carrier web from each of said segments.

18. A process as recited in claim 17, including a further step of die cutting by using electromagnetic radiation in one of the ultraviolet, visible or infrared regions of the light spectrum, each of said segments prior to the step of placing each of said segments on a carrier web.

19. A process as recited in claim 17, wherein said step of placing each of said segments is accomplished by positioned said segments in at least a slightly overlapping relationship of overlap greater than at least about 1/64 of an inch.

20. A process as recited in claim 17, wherein said high resolution quality printing is produced at a resolution of greater than about 150 lines per inch.
